(19) United States
(12) Patent Application Publication
(10) Pub. No.: US 2008/0223096 A1
(43) Pub. Date: Sep. 18, 2008

(54) Indirect lock interface

(76) Inventors: Robert Loughlin, Stanton, NJ (US); John Loughlin, Lebanon, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/009,832

(22) Filed: Jan. 22, 2008

Related U.S. Application Data
(60) Provisional application No. 60/881,713, filed on Jan. 22, 2007.

(51) Int. Cl. E05B 9/04

(52) U.S. Cl. 70/449

(57) ABSTRACT

A lock mechanism of the present invention includes a housing having an exterior surface and a locking cylinder associated with the housing. The locking cylinder preferably includes a rotatable element for locking and unlocking the locking cylinder, the rotatable element having a portion adapted to mate with an interface of a tool having a flexible portion leading to the interface. The lock mechanism preferably further includes a non-linear guide passage extending between the exterior surface of the housing and the rotatable element of said locking cylinder. Preferably, the flexible portion of the tool may be inserted into the guide passage to mate the interface with the rotatable element of the locking cylinder to permit manipulation of the rotatable element of the locking cylinder by the tool.

### CROSS-REFERENCE TO RELATED APPLICATIONS

This application claims the benefit of the filing date of U.S. Provisional Patent Application No. 60/881,713, filed Jan. 22, 2007, the disclosure of which is hereby incorporated herein by reference.

### FIELD OF THE TECHNOLOGY

The present invention relates to an indirect lock interface configured to thwart an attack on a locking mechanism of a lock, and in particular it relates to such an indirect lock interface which may be used in association with a key, combination dial, or tool, to provide a pathway, preferably a non-linear pathway, to the locking mechanism.

The present invention relates to lock interfaces for conventional key function, combination function, or unconventional tool operated combination locks, such as those unconventional tool operated combination locks disclosed in U.S. patent application Ser. Nos. 11/186,698 and 11/255,659. More particularly, the present invention relates to the coupling between the key combination dial, or tool, and the articulating element of the lock mechanism.

### BACKGROUND OF THE INVENTION

Lock mechanisms are vulnerable to direct attack against the keyway of key function devices and the manipulation elements of combination function devices whether conventional or unconventional. These attacks may include surreptitious means such picking, decoding, bypassing, impressioning, bumping, or other undetectable means. Other means include forced attacks including torsional, pulling, punching, drilling, or other covert means that may generally be detected by inspection. The introduction of foreign matter into the mechanism by nature also represents a threat to the reliable functioning of locking devices. However, each of these surreptitious, forced, or natural “attacks” require relatively free access to the point of attack, or interface between the lock mechanism and opening means.

The history of locks of all forms reveals many attempts to protect the mechanisms by using covers, doors, shields, tamper indicative devices, complex entry arrangements, articulated multipart keys, and other means. These efforts increased with the introduction of complex and fragile lock mechanisms after the mid-nineteenth century. The protection of a dial combination lock as seen in U.S. Pat. No. 3,209,569 to Bryson (1965) demonstrates the need. A means to reduce access to the keyway is seen in U.S. Pat. No. 3,343,386 to Hall (1967), U.S. Pat. No. 3,765,199 to Wiczer (1973), and U.S. Pat. No. 4,686,840 to McCarroll (1987). Multipart-segmented articulating keys are seen in U.S. Pat. No. 5,671,623 to Hsu (1997). These and many other similar devices and inventions have attempted to reduce the vulnerabilities described. Nevertheless, these various concepts find little practical application due to their complexity, difficulty in use, limited protection provided, and cost.

### SUMMARY OF THE INVENTION

Accordingly, the present invention addresses these concerns through the use of novel and indirect couplings, or interfaces, between the lock opening means, such as a key, dial, or tool, and the locking mechanism of the lock. The present invention provides for several configurations that are preferably economical to fabricate, easy to install and to use, and assure the needed improved protection against the types of attacks described, and those which are similar.

The key function lock mechanism embodiments preferably incorporate an indirect linkage as appropriate to the several styles of pin tumbler, disc, wafer, or rotary tumbler cylinders in common use. The variety of pin tumbler mechanisms includes pins arranged in linear, radial, or axial (tubular) format. Each of these represents a specific configuration requiring different elements to achieve the advantages of the invention.

In one embodiment of the radial or axial (tubular) pin tumbler configuration the key would preferably be made with the engaging element arranged at a right angle to the bow of the key and also be of minimal thickness. The cylinder would preferably be located behind a protective cover containing a passage to accept the low profile key and provide for the key, when engaged, to be rotated sufficiently to manipulate the lock mechanism and unlock the lock. The cover may contain a moving element to press, or “drive home,” the key engaging element into the cylinder mechanism to assure reliable function.

In another embodiment, a linear pin tumbler configuration key may be provided with a hinged, flexible, or articulated link between the bow and the bitted portion. The cylinder would preferably be located behind a protective cover containing a passage to accept the key and its required travel. The key preferably would follow a substantially circuitous or otherwise non-linear path to engage the keyway. The link between the bow and the bitted portion of the key may provide the means to press the key into the keyway and cylinder mechanism. When engaged, the key bow may be moved in rotation about the centerline of the cylinder sufficiently so as to manipulate the cylinder mechanism and unlock the lock. When the lock has been unlocked, the key may be rotated back to the starting position, the bow, with the bitted element attached pulled from the cylinder, and the key recovered. The cylinder with which it functions generally determines the length of the bitted element of the key. The passage in the protective cover may be of a shape and size to diminish the opportunity for a bumping attack. This unique arrangement provides protection from the threat of bumping not found in the prior art.

Alternative embodiments of the combination lock configurations may include the use of a flexible continuous shaft to transmit the necessary torque from the lock opening means, such as a tool or dial, to the drive shaft of the locking cylinder. This shaft would preferably be arranged to fit within an indirect or curved path between the lock opening means and the cylinder. This embodiment may be an arrangement within a cover enclosing a traditional installed locking cylinder, incorporated within the handle of a lever lock, integrated into the body of a padlock, provided as an accessory for a generic padlock, or by other means. This embodiment may also function with either the dial of a conventional combination lock as appropriately modified, a specific tool, or other mechanism.

In alternative embodiments of the invention, the keyway or face of the locking cylinder mechanism is protected from direct attack by a covering element appropriate to the specific configuration, the mechanism may be manipulated easily and reliably, and the vulnerable elements are hidden and shielded from attack.

A first aspect of the present invention is a lock mechanism. In accordance with one embodiment of the present invention, the lock mechanism includes a housing having an exterior surface and a locking cylinder associated with the housing. The locking cylinder preferably includes a rotatable element for locking and unlocking the locking cylinder, the rotatable element having a portion adapted to mate with an interface of a tool having a flexible portion leading to the interface. The lock mechanism preferably further includes a non-linear guide passage extending between the exterior surface of the housing and the rotatable element of said locking cylinder. Preferably, the flexible portion of the tool may be inserted into the guide passage to mate the interface with the rotatable element of the locking cylinder to permit manipulation of the rotatable element of the locking cylinder by the tool.

In accordance with one embodiment of this first aspect of the invention, the locking cylinder and the housing include a longitudinal central axis. The longitudinal central axis of the housing and the longitudinal central axis of the locking cylinder may be parallel and not coaxial. Alternatively, the longitudinal central axis of the housing and the longitudinal central axis of the locking cylinder may be non-parallel.

In accordance with another embodiment of this first aspect of the present invention, the longitudinal central axis of the housing and the longitudinal central axis of the locking cylinder are perpendicular.

In accordance with yet another embodiment of this first aspect of the present invention, the locking cylinder and the non-linear guide passage are contained within the housing.

A second aspect of the present invention is a lock mechanism including a housing having an exterior surface and a locking cylinder at least partially contained with the housing. The locking cylinder preferably includes a rotatable element for locking and unlocking the locking cylinder, the rotatable element having a portion adapted to mate with an interface portion of a tool. The lock mechanism preferably further includes an attachment member having a plurality of exterior surfaces and a guide passage contained within the attachment member such that at least a portion of the guide passage extends between a first of the plurality of exterior surfaces of the attachment member and a second of the plurality of exterior surfaces of the attachment member. Preferably, a flexible portion of the tool may be inserted into the guide passage and mated with the rotatable element of the locking cylinder when the second of the plurality of exterior surfaces of the attachment member is abutted appropriately against the exterior surface of the housing, whereby the rotatable element of the locking cylinder may be manipulated by the tool.

In accordance with one embodiment of this second aspect of the present invention, one of the exterior surfaces of the attachment member is configured to mate to the exterior surface of the housing when the locking mechanism is locked. Alternatively, when the locking mechanism is unlocked the attachment mechanism is configured to separate from the housing such that the exterior surface of the housing and no exterior surface of the attachment mechanism are in engagement.

In accordance with another embodiment of this second aspect of the present invention, the first and second surfaces of the attachment member are formed from non-parallel planes.

In accordance with yet another embodiment of this second aspect of the present invention, the guide passage is non-linear.

In accordance with a method of manipulating a lock mechanism of the present invention, the lock mechanism including a housing having an exterior surface, a locking cylinder associated with the housing, the locking cylinder including a rotatable element for locking and unlocking the locking cylinder, the rotatable element having a portion adapted to interface with a tool and a non-linear guide passage extending between the exterior surface of the housing and the rotatable element of the locking cylinder, the method including inserting a first end of the tool into the non-linear guide passage; guiding the first end of the tool such that the first end of the tool engages the rotatable element of the locking cylinder; and rotating the tool to manipulate the rotatable element of the locking cylinder.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 shows a perspective view of a tool operated combination (TOC) locking cylinder installed protectively within a structure in accordance with one embodiment of the present invention, the figure illustrating an indirect or substantially non-linear guide passage between the lock and a tool having a flexible engaging portion.

FIG. 2A-C show examples of three possible indirect interface paths available to access a protected installation of a TOC cylinder for use with a tool having a flexible engaging portion capable of coupling the tool with the locking cylinder.

FIG. 3 shows a perspective view of a generic lever lock handle with a TOC locking cylinder installed securely within a structure and a tool having a flexible engagement portion.

FIG. 4 shows a perspective view of an embodiment of the present invention providing protection for a TOC cylinder installed within a generic padlock. Shown is an attachment member containing a non-linear guide passage for acceptance of a flexible engaging element either as part of a tool or as fixed within the passage.

FIG. 5A shows a perspective view of an embodiment of the invention providing protection for a generic tubular cylinder adapted to be manipulated by a tubular key with a low profile. Shown is a perspective view of a lock mechanism and key.

FIG. 5B shows a cut-away view of a fixed protective housing provided with a passage for a key to rotate.

FIG. 5C shows a cut-away view of a protective housing with passage that rotates with a key.

FIG. 5D shows a side view of the protective housing with passage and key of FIG. 5C.

FIG. 6 shows a perspective view of a lock protected by an inventive cover including a substantially non-linear guide passage to receive a key or tool.

### DETAILED DESCRIPTION

In the following are described embodiments of the indirect lock interface in accordance with the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. Where like elements have been depicted in multiple embodiments, identical reference numerals have been used in the multiple embodiments for ease of understanding.

It will become evident to one skilled in the art that several objectives and advantages of this invention follow from the novel method by which the traditional security functions are achieved using the features of the invention.

The conventional engagement of keys or manipulation of combination locks is accomplished by means of direct engagement or coupling with the keyway or knob of the mechanisms. Typically, the entryway into the locking mechanism is exposed at the exterior surface of the lock housing, such that a key or tool may be visually aligned and inserted therein. The lock may then be unlocked, unlatched, and opened by proper manipulation of the engaged key or tool within the lock mechanism.

Such an arrangement suffers from detrimental flaws. One of which is its susceptibility to being compromised by materials from the environment in which it is placed. For example, if the lock is placed outside, dirt may enter the entryway causing it to clog. Water or moisture may also enter, causing the interior components to rust or otherwise lose the ability to interact seamlessly. Other concerns involve those of malfeasants. Certain individuals may be motivated to attack locks, and those with exposed entryways are particularly vulnerable to attacks such as picking, bumping, or simple drilling.

The present invention includes the provision of a novel means to accomplish this engagement or coupling in a secure manner. More specifically, the present invention discloses means of extended pathways which may be hollow tubes adapted to accept a flexible shaft portion of a tool or may themselves include internal and rotatable shafts, or the like, for protecting lock mechanisms from being directly attacked, while offering novel means and methods for opening such protected locks. The pathways, shafts, or other features preferably extend through circuitous or substantially non- linear paths.

By use of the phrase “substantially non-linear,” it is to be understood that the shaft or path may include portions that are indeed linear, whether coaxial with the centerline of the locking mechanism or not. In addition, it is to be understood that the linear portions may comprise a majority of the path. Indeed, the phrase “substantially non-linear” should be understood to include paths that are anything but completely linear.

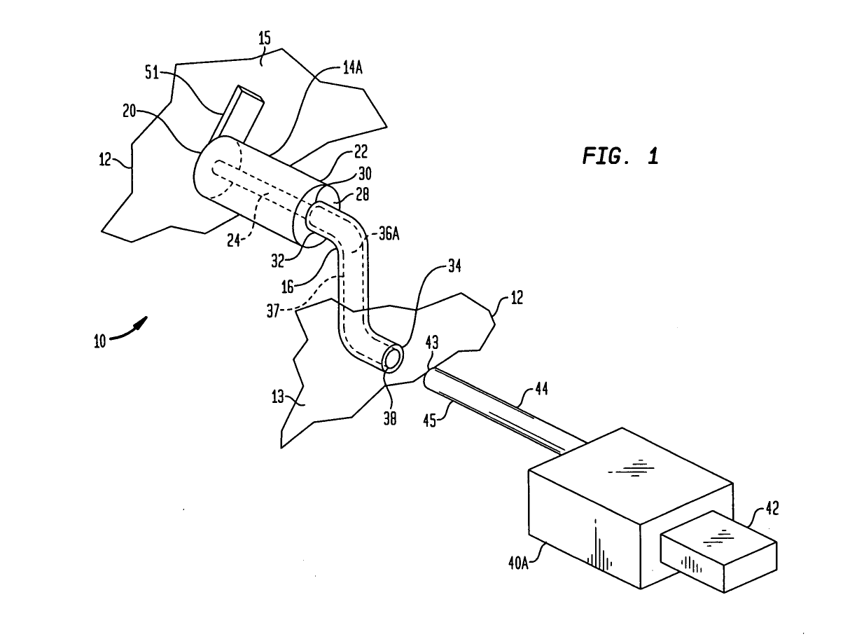

The embodiment of the invention shown in FIG. 1 depicts a perspective view of a tool operated lock (TOC) cylinder installed within a structure. In a conventional arrangement, the entryway to the locking mechanism of the TOC lock would typically be exposed at an outer surface of the structure. However, such positioning would subject the lock to direct attack, as discussed above. In accordance with certain aspects of the present invention, however, the lock may be set-back within the structure and the structure may include a circuitous or substantially non-linear path to the lock. An attack against the cylinder must therefore overcome the protections provided by the material of the structure and the indirect path to the cylinder. The non-linear path from a key entryway to a locking cylinder of a lock mechanism may be created through casting, for example by casting the structure in two parts which are joined along the pathway.

A substantially non-linear internal guide passage may provide for the indirect engagement between a lock opening tool and the TOC cylinder. Alternatively, a solid flexible shaft may be inserted into the substantially non-linear passage such that rotatable engagement of the solid flexible shaft at a first end adjacent a key entryway would cause the second end of the shaft engaged to the locking cylinder to also rotate. The lock mechanism would thereby lock or unlock due to the rotation of the flexible shaft. As such, the flexible shaft may be an integral part of the TOC cylinder, a removable element, or an integral part of the tool. The solid flexible shaft may be secured in the passage by c-clips or other means.

Flexible shafts may be configured in a diameter which is less than that required for successful attack by drilling. For example, where the materials of construction of the lock would require a drill bit of a given diameter to drill out the lock mechanism, the guide tube may be configured to a lesser diameter, such that if a drill bit were passed through the shaft, only one which is insufficient to drill out the lock would successfully pass. Additionally, the manufacturing specifics of the flexible shaft and relative location of the lock mechanism, advantageously buried in an unknown position within the housing, may be proprietary such that a malfeasant would not know where in the structure to drill in a linear-based drilling attack aimed at the hidden lock mechanism.

Referring to the drawings, wherein like reference numerals refer to like elements, there is shown in FIG. 1 an embodiment of a lock mechanism 10 with tool 40A. As shown in FIG. 1, lock mechanism 10 generally includes a housing 12, a locking cylinder 14A, and a substantially non-linear passage 16. In one embodiment, passage 16 is essentially hollow, such that a flexible shaft portion of a tool may enter the passage to then mate with the locking mechanism. In other embodiments, the passage 16 may be filled with a flexible shaft, which is already mated with the locking mechanism. In such case, the tool may include appropriate mating mechanisms to mate with the opposite end of the flexible shaft to rotate same.

In use, an internal guide passage 36A of passage 16, such as that formed by a tubular structure, is substantially non-linear between a first end 32 and a second end 34 of passage 16, and is hollow. Generally, locking cylinder 14A and passage 16 are contained within an enclosed housing 12. Examples of such housings include doors, gates, fences, and safes, as well as the housing of conventional-type locks, such as padlocks, straight shackle locks, and the like.

As shown in FIG. 1, housing 12 includes at least a first and second surface 13, 15. It is contemplated in the present invention that while a portion of locking cylinder 14A and passage 16 may be contained within housing 12, a portion of locking cylinder 14A and passage 16 may also not be contained within housing 12, in such case the passage 16 may also include additional surrounding structure, such as internal guide passage 36A. Preferably, the entire locking cylinder 14A and all but a portion of the passage 16 are embedded within the housing 12.

Housing 12 can be any structure within which locking cylinder 14A and passage 16 as formed by internal guide passage 36A can be placed or affixed. A non-exhaustive list of examples of affixation methods for affixing locking cylinder 14A and/or passage 16 to a surface of housing 12 include press-fitting, welding, gluing, and threading. In addition, such affixation or mating may be by proprietary means, or alternatively may be additional well known configurations, such as Forx, Phillips, Hex, Robertson, or the like. Otherwise, the locking cylinder 14A may be simply placed within the housing 12, such as by constructing housing 12 around locking cylinder 14A.

Preferably, locking cylinder 14A includes a first end 20, a second end 22, and a rotatable element 24. It should be understood that such a generic locking cylinder can be adapted for use in the present invention. The internal structure of a generic locking cylinder is well known in the art and will not be explained in detail.

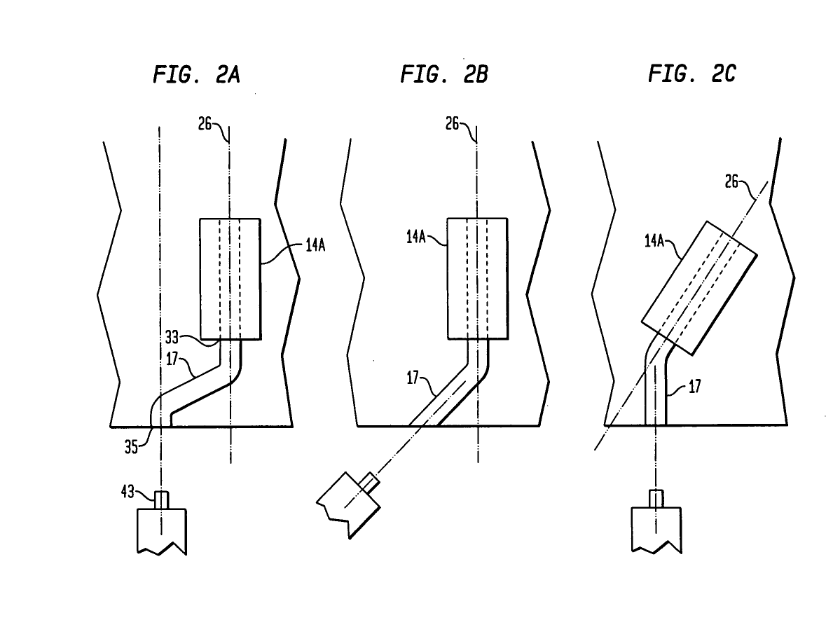

Preferably, first end 20 of locking cylinder 14A is affixed to a surface of housing 12 or is at least found within the housing. A longitudinal axis 26 (FIG. 2A) of locking cylinder 14A is generally perpendicular to a surface of housing 12 when locking cylinder 14A is affixed to a surface of housing 12. Rotatable element 24 is generally coaxial with longitudinal axis 26 of locking cylinder 14A. Second end 22 of locking cylinder 14A typically includes an exterior surface 28 having an aperture 30 configured to receive a portion of passage 16 and internal guide passage 36A.

Preferably, passage 16 includes a first end 32, a second end 34, and a guide passage 36A extending through first end 32 and second 34 of passage 16. First end 32 of passage 16 is configured to be received within aperture 30 of locking cylinder 14A. First end 32 of passage 16 is preferably press-fit into aperture 30 such that passage 16 resists rotation while inside aperture 30. First end 32 of passage 16 may also engage aperture 30 through any of the above described examples of affixation methods.

Preferably, the alignment of passage 16, or alternatively a solid flexible shaft 17 contained within the passage (FIGS. 2A-2C) allows a portion of guide passage 36A, or alternatively shaft 17, to be coaxial with rotatable element 24 of locking cylinder 14A while a portion of guide passage 36A, or alternatively shaft 17, is not coaxial with rotatable element 24 of locking cylinder 14A as shown in FIGS. 2A-C showing three possible examples of indirect interface paths.

As described above, first end 32 of passage 16 is received within aperture 30 of locking cylinder 14A. At the exterior surface 28 of locking cylinder there is formed an interface between locking cylinder 14A and passage 16. Another interface is formed at the surface where second end 34 of passage 16 is affixed to housing 12. Preferably, the interface between locking cylinder 14A and passage 16 forms a non-linear guide passage 36A with the interface between second end 34 of passage 16 and housing 12.

As further shown in FIG. 1, second end 34 of passage 16 is affixed to a surface of housing 12. Generally, the surfaces of housing 12 that locking cylinder 14A and passage 16 are affixed to are parallel. It is contemplated by the present invention that the surfaces of housing 12 that locking cylinder 14A and passage 16 are affixed to are non-parallel. Preferably, the surface of housing 12 that second end 34 of passage 16 is affixed to includes an aperture 38. Second end 34 of passage 16 is preferably press-fit into aperture 38 such that passage 16 resists rotation while inside aperture 38. Second end 34 of passage 16 may also engage aperture 38 through any of the above described examples of affixation methods. Preferably, the flexibility of passage 16 allows a portion of guide passage 36A to be perpendicular to the surface of housing 12 that second end 34 of substantially non-linear passage 16 is affixed to.

A tool 40A used to lock and unlock lock mechanism 10 is shown in FIG. 1. Tool 40A preferably includes an enabling element 42 and a flexible engagement element 44. Flexible engagement element 44 of tool 40A is designed to be received within guide passage 36A of passage 16 and follow a non-linear guide passage 36 through passage 16 and into locking cylinder 14A, wherein an interface 43 at the end of flexible engagement element 44 may engage rotatable element 24 of locking cylinder 14A.

In the embodiments shown in FIGS. 2A-2C, an engagement portion 43 of a tool is configured to engage only a second end 35 of solid flexible shaft 17, wherein rotation of the tool drives rotation of shaft 17 such that a first end 33 of shaft 17 is rotated thereby causing attachment mechanism 24 of locking cylinder 14A to be engaged and lock or unlock lock mechanism 10.

Flexible engagement element 44 of tool 40A is configured to be received within guide passage 36A of passage 16. It is contemplated in the present invention that at least a portion of an external surface 45 of flexible engagement element 44 that is received within guide passage 36A corresponds to an internal surface 37 of guide passage 36A such that flexible engagement element 44 may not rotate within guide passage 36A. This will allow a user having tool 40A to easily lock and unlock lock mechanism 10 by inserting flexible engagement element 44 into guide passage 36A in a particular position wherein flexible engagement element 44 will enter into locking cylinder 14A in a corresponding position that engages rotatable element 24 of locking cylinder 14A. By doing so, the rotations required to unlock the lock may be properly calibrated.

Alternatively, flexible engagement element 44 may be rotated within guide passage 36A such that a user would have to rotate tool 40A to find a correct position before flexible engagement element 44 can be received within aperture 30 of locking cylinder 14A, again to calibrate the rotations required to unlock the lock.

The locking cylinder 14A also includes a conventional latch 51. Briefly, and in accordance with certain embodiments of the invention, once the tool 40A is manipulated through its unlocking sequence the entire tool may be manually turned to rotate the latch to allow opening of the locked structure. In other embodiment, the latch 51 may automatically rotate once the lock is unlocked.

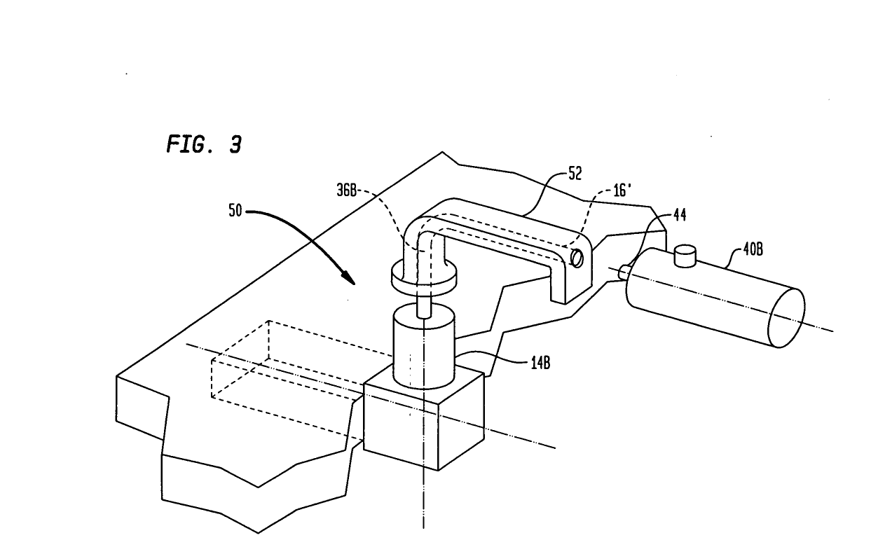

Another embodiment of the invention is shown in FIG. 3 in which the TOC (or other lock) may be securely located within the mechanism of a lever handle lock 50, of the type found on conventional doors. The connecting non-linear guide passage 36B between a tool 40B and a locking cylinder 14B is illustrated in cut-away and travels along the length of a handle 52 of lever lock handle 50 in the embodiment shown. Passage 36B may be configured with an integral substantially non-linear passage 16′ adapted to mate with tool 40B to provide the necessary engagement and transmission of torsional forces to unlock lock 50, or may be configured to accept a removable element 44 attached to tool 40B for such purpose.

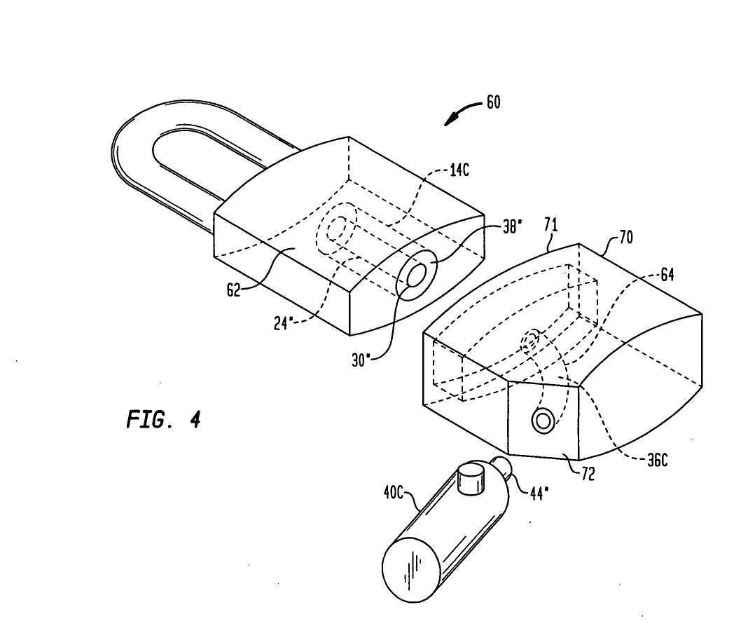

Another embodiment of the present invention, illustrated in FIG. 4, shows a perspective view of a U-shackle padlock 60 incorporating a locking cylinder 14C within a body 62 of padlock 60. As shown in FIG. 4, an attachment member or accessory 70 is adapted to be secured on an exterior surface 38″ of padlock 60. Preferably, accessory 70 includes a non-linear guide passage 36C therein. Accessory 70 may be provided with an integral guide tube 64 including the non-linear guide passage 36C or rather may be provided with a cast non-linear guide passage without tube 64. Non-linear guide passage 36C is configured to receive therein a flexible engagement element 44″ that is attached to tool 40C. It will also be appreciated that accessory 70 may be made as part of padlock body 62.

As shown in FIG. 4, padlock 60 includes body or housing 62 having an exterior surface 38″ and locking cylinder 14C. Locking cylinder 14C preferably includes a rotatable element 24″ for locking and unlocking locking cylinder 14C. Rotatable element 24″ is configured to interface with a flexible engagement element 44″ of tool 40C. Accessory 70 preferably further includes a plurality of exterior surfaces, wherein a first end of non-linear guide passage 36C opens at a first exterior surface 71 and a second end of non-linear guide passage 36C opens at a second exterior surface 72. At least a portion of non-linear guide passage 36C extends between a first of the plurality of exterior surfaces 71 of attachment member 70 to a second of the plurality of exterior surfaces 72 of attachment member 70.

Preferably, flexible engagement element 44″ of tool 40C may be inserted into non-linear guide passage 36C and interfaced with rotatable element 24″ of locking cylinder 14C to manipulate rotatable element 24″ of locking cylinder 14C.

Exterior surface 71 of accessory 70 is configured to mate to or otherwise abut exterior surface 38″ when housing 62 and accessory 70 are assembled. Non-limiting examples of how housing 62 and accessory 70 are assembled together include accessory 70 being pinned to housing 62 or welded thereto. Preferably, first surface 71 and second surface 72 of accessory 70 each include a plane that is not parallel to each other thereby creating non-linear guide passage 36C.

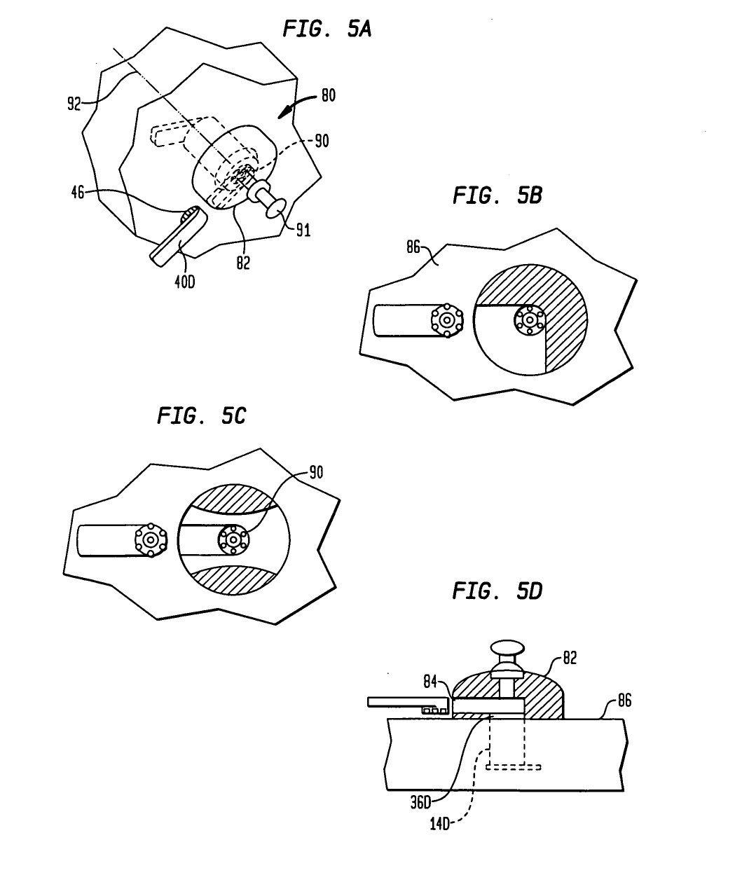

FIG. 5A shows another embodiment of the present invention where an axial (tubular) pin tumbler lock 80 is protected by an inventive cover 82 including an aperture 88 to receive a tool 40D. Tool 40D includes a tubular key portion 46, having lock engagement features which are well known in the art. Tool 40D is provided with a bow 48 at ninety degrees to an axis of tubular key portion 46. Tubular key portion 46 and bow 48 must have a combined width which allows these elements of tool 40D to be received within aperture 84 of cover 82. An engagement element 90 located on a centerline 92 of a locking cylinder 14D may be provided to assure reliable engagement of the tubular key portion 46 within locking cylinder 14D once key portion 46 is inserted fully within aperture 84 of cover 82 and the tool 40D is pushed in a downward direction by a plunger 91 to “drive-home” tool 40D into engagement with locking cylinder 14D and specifically engagement element 90.

As shown in FIG. 5B, cover 82 may be fixed to a structure 86 and aperture 84 may be sized sufficiently to permit the engaged tool 40D to rotate and manipulate locking cylinder 14D into the unlocked and open position. FIGS. 5C and 5D show that cover 82 may be free to rotate in the manner of a thumb turn device when tool 40D is properly engaged with locking cylinder 14D. No matter which embodiment is provided, access for tool 40D to the protected locking cylinder 14D is preferably by means of a non-linear passage 36D (this particular passage turning a 90 degree bend) protecting locking cylinder 14D from both forced and surreptitious attacks.

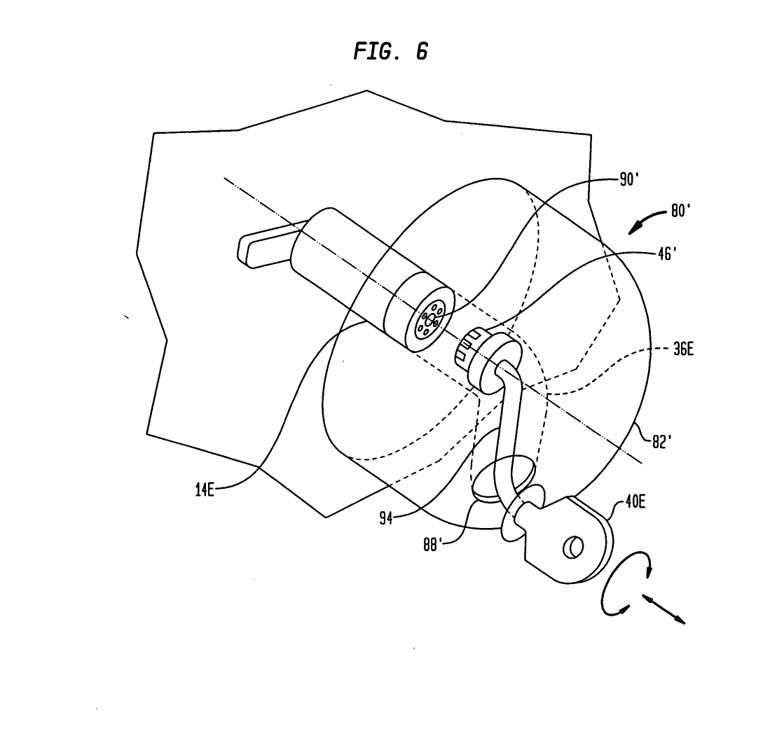

FIG. 6 shows another embodiment of lock 80 denoted by reference numeral 80′, wherein lock 80′ is protected by an inventive cover 82′ including an aperture 88′ to receive a key or tool 40E. Tool 40E includes a tubular key portion 46′. Tool 40E is provided with a substantially non-linear shaft portion 94 configured to direct tubular key portion 46′ through non-linear guide passage 36E until tubular key portion 46′ engages movable element 90′ of locking cylinder 14E.

Alternative embodiments of the combination lock configurations may include the use of a flexible continuous shaft to transmit the necessary torque from the lock opening means, such as a tool or dial, to the drive shaft of the locking cylinder. This shaft would preferably be arranged to fit within an indirect or curved path between the lock opening means and the cylinder. This embodiment may be an arrangement within a cover enclosing a traditional installed locking cylinder, incorporated within the handle of a lever lock, integrated into the body of a padlock, provided as an accessory for a generic padlock, or by other means. This embodiment may also function with either the dial of a conventional combination lock as appropriately modified, a specific tool, or other mechanism.

As has therefore been shown and described, the novel indirect lock interface provides means by which a lock opening means, such as a key, dial, or tool, may be engaged with a lock opening mechanism, such as a disc or pin tumbler for example, through an indirect passage, such as a non-linear passage. Such passage protects the lock opening mechanism from attack, both forced and surreptitious, while also serving to protect the lock mechanism from debris and such. The passage may be formed integrally with the lock housing or may be provided as a separate attachment for association with the lock. The attachment may be fixed or may be moveable, such as by rotation. Preferably, the path of such passage is circuitous such that there is not a direct path to the lock mechanism.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A lock mechanism comprising:
a housing having an exterior surface;
a locking cylinder associated with said housing, said locking cylinder including a rotatable element for locking and unlocking the locking cylinder, said rotatable element having a portion adapted to mate with an interface of a tool having a flexible portion leading to the interface; and
a non-linear guide passage extending between the exterior surface of said housing and said rotatable element of said locking cylinder;
wherein the flexible portion of the tool may be inserted into said guide passage to mate the interface with said rotatable element of the locking cylinder to permit manipulation of the rotatable element of the locking cylinder by the tool.

2. The lock mechanism of claim 1, wherein the housing includes a longitudinal central axis.

3. The lock mechanism of claim 2, wherein the locking cylinder includes a longitudinal central axis.

4. The lock mechanism of claim 3, wherein the longitudinal central axis of the housing and the longitudinal central axis of the locking cylinder are substantially parallel but not substantially coaxial.

5. The lock mechanism of claim 3, wherein the longitudinal central axis of the housing and the longitudinal central axis of the locking cylinder are substantially non-parallel.

6. The lock mechanism of claim 3, wherein the longitudinal central axis of the housing and the longitudinal central axis of the locking cylinder are substantially perpendicular.

7. The lock mechanism of claim 1, wherein the locking cylinder and the non-linear guide passage are contained entirely within the housing.

8. A lock mechanism comprising:
a housing having an exterior surface;
a locking cylinder at least partially contained within said housing, said locking cylinder including a rotatable element for locking and unlocking said locking cylinder, said rotatable element having a portion adapted to mate with an interface portion of a tool;
an attachment member having a plurality of exterior surfaces; and
a guide passage contained within the attachment member such that at least a portion of said guide passage extends between a first of the plurality of exterior surfaces of the attachment member and a second of the plurality of exterior surfaces of the attachment member;
wherein a flexible portion of the tool may be inserted into said guide passage and mated with said rotatable element of said locking cylinder when the second of the plurality of exterior surfaces of the attachment member is abutted appropriately against the exterior surface of the housing, whereby the rotatable element of the locking cylinder may be manipulated by the tool.

9. The lock mechanism of claim 8, wherein the first and second surfaces of the attachment member are formed from non-parallel planes.

10. The lock mechanism of claim 8, wherein the guide passage is non-linear.

11. A method of manipulating a lock mechanism including a housing having an exterior surface; a locking cylinder associated with the housing, the locking cylinder including a rotatable element for locking and unlocking the locking cylinder, the rotatable element having a portion adapted to interface with a tool; and a non-linear guide passage extending between the exterior surface of the housing and the rotatable element of the locking cylinder, the method comprising:
inserting a first end of the tool into the non-linear guide passage;
guiding the first end of the tool such that the first end of the tool engages the rotatable element of the locking cylinder; and
rotating the tool to manipulate the rotatable element of the locking cylinder.

12. The method of claim 11, wherein the non-linear guide passage is contained within a protective cover, the method further comprising:
rotating a protective cover housing the non-linear guide passage.

13. A lock mechanism comprising:
a housing having an exterior surface;
a locking cylinder associated with said housing, said locking cylinder including a rotatable element for locking and unlocking the locking cylinder, said rotatable element having a portion adapted to mate with an interface of a shaft, the shaft located within a substantially non-linear pathway, the pathway extending between the exterior surface of said housing and said rotatable element of said locking cylinder;
wherein an engagement portion a tool may be mated with an end of the shaft adjacent to the exterior surface of the housing such that rotation of the engagement portion of the tool causes rotation of the shaft and rotatable element of the locking cylinder to lock or unlock the locking cylinder.

14. The lock mechanism of claim 13, wherein the housing includes a longitudinal central axis.

15. The lock mechanism of claim 14, wherein the locking cylinder includes a longitudinal central axis.

16. The lock mechanism of claim 15, wherein the longitudinal central axis of the housing and the longitudinal central axis of the locking cylinder are substantially parallel but not substantially coaxial.

17. The lock mechanism of claim 15, wherein the longitudinal central axis of the housing and the longitudinal central axis of the locking cylinder are substantially non-parallel.

18. The lock mechanism of claim 15, wherein the longitudinal central axis of the housing and the longitudinal central axis of the locking cylinder are substantially perpendicular.

19. The lock mechanism of claim 13, wherein the locking cylinder and the non-linear guide passage are contained entirely within the housing.
